(19) United States
(12) Patent Application Publication
(10) Pub. No.: US 2008/0132199 A1
(43) Pub. Date: Jun. 5, 2008

(54) Portable Radio Device Having Emergency Notifying Function, Emergency Notification Apparatus, and Emergency Notification System

(75) Inventor: Kazuko Hirata, Tokyo (JP)

Correspondence Address: GRIFFIN & SZIPL, PC, SUITE PH-1, 2300 NINTH STREET, SOUTH, ARLINGTON, VA, 22204, US

(73) Assignee: JUPITER NET INCORPORATED, Tokyo (JP)

(21) Appl. No.: 11/722,985

(22) PCT Filed: Dec. 27, 2005
(86) PCT No.: PCT/JP05/23864

§ 371 Date: Dec. 6, 2007

(30) Foreign Application Priority Data
Dec. 27, 2004 (JP) 2004-376654

(51) Int. Cl. H04M 11/04

(52) U.S. Cl. 455/404.2

(57) ABSTRACT

A portable radio device, an emergency notification apparatus, and an emergency notification system are provided. The portable radio device 10 has an emergency button that can be operated by the user of the device 10. When the button is operated, an identification data is added to the date and time data, position data, and image data obtained at that time, thereby generating emergency notification data. Then, the emergency notification data is transmitted by radio to the emergency notification apparatus 70 along with an emergency notification signal. When receiving the emergency notification signal, the apparatus 70 stores these data in a database 107 and performs a notification that the user is in a state of emergency to predetermined contact addresses 1 to n.

### TECHNICAL FIELD

The present invention relates to a portable radio device having an emergency notifying function, an emergency notification apparatus, and an emergency notification system. More particularly, the invention relates to a portable radio device, an emergency notification apparatus, and an emergency notification system, which make it possible to notify quickly and easily a state of emergency such as a crime, accident, and disaster to desired persons or institutions using a function (i.e., GPS receiving function) of receiving the radio wave emitted from a GPS (Global Positioning System) satellite and a function of picking up images with digital cameras or the like, and which are effective to crime prevention.

Here, the wording “portable radio device” has a meaning of a portable device capable of speech communication and/or data transmission by radio, which includes various types of portable radio devices, such as portable telephones, PHS (Personal Handyphone System) telephones, portable communication devices, PDAs (Personal Digital Assistants), portable-type computers, portable-type data terminals, automobile telephones, marine radio, and aviation radio.

### BACKGROUND ART

Conventionally, portable telephones connectable to the Internet and digital cameras for picking up images of objects and recording them in the form of digital data have already been extensively popularized. Moreover, recently, portable telephones with the Internet connecting function, electronic mail transmitting/receiving function, and digital camera function have been developed and placed on the market, and are now being popularized. As a result, transmission of image data obtained by an incorporated digital camera into a portable telephone or a stand-alone digital camera to a desired information terminal (e.g., a portable telephone, personal computer, or PDA) by way of the Internet has become comparatively easy. Furthermore, PDAs having the GPS receiving function incorporated therein or the like have come onto the market also.

On the other hand, recently, in our country also, crimes such as robbery, stoking, and kidnapping have often occurred and thus, there is the need for crime prevention systems that cope with these crimes. Taking such the circumstances as above into consideration, conventionally, various types of crime prevention apparatuses/systems and crime notification apparatuses/systems which utilize portable telephones each having a built-in digital camera function have been proposed.

For example, Patent Document 1 discloses a portable telephone which comprises image signal processing means for capturing image data from the camera section and processing the image data, memory means for storing the image data, image comparing means for comparing the image data thus obtained. Moreover, Patent Document 1 further discloses a crime prevention apparatus (crime prevention system) wherein a monitoring camera for photographing a monitoring area is installed, and image information obtained by the monitoring camera or judgment information based on the image information is transmitted to a monitor side, characterizing in that the above-identified portable telephone is used as the monitoring camera. With this crime prevention apparatus (crime prevention system), crimes can be prevented or notified by transmitting the images of the monitoring area photographed with the portable telephone to the monitor side. As a result, a highly reliable crime prevention apparatus is obtainable extremely easily at low cost.

Patent Document 2 discloses a crime prevention apparatus as follows. When a sensor section installed in a home detects a housebreaker, a controller section dials automatically a predetermined telephone number of a next-generation type portable telephone (which is connectable to the Internet and which is able to reproduce moving images) with an automatic dialing device, thereby transmitting a telephone warning to the next-generation type portable telephone possessed by an owner of the home by way of telephone lines. The owner of the home acquires moving images from a camera section, which are delivered by the controller section, by way of the Internet with the next-generation type portable telephone. Then, the owner judges the presence or absence of a housebreaker from the moving images thus acquired. When the owner judges that a housebreaker is present, he or she gives a telephone notification to the police or a private security company by using the next-generation type portable telephone. With this crime prevention apparatus, a housebreaker into someone's home can be surely detected from a remote place and false reports can be reduced, thereby raising the reliability of the apparatus.

Patent Document 3 discloses a vehicle-mounted crime prevention apparatus comprising an interface section for making communication with a portable telephone having a built-in digital camera, a trigger signal inputting section for inputting a value of a door open/close switch, an illumination control means for controlling a turn-on time of an illumination device for illuminating the inside of a car, a shutter control means for outputting an ON signal of a shutter of the digital camera to the portable telephone, and an image data transmission instruction means for instructing the portable telephone to transmit image data of photograph of a face. Patent Document 3 further discloses a vehicle-mounted crime prevention system comprising a portable telephone with a built-in digital camera for making a photograph of a passenger's face and for making communication with the outside, a car, a vehicle-mounted crime prevention apparatus for controlling the photographing of the passenger's face, an illumination device for illuminating the inside of the car, a door open/close switch for rear riding doors, an emergency switch, a fare mater, an emergency indicator light for notifying a state of emergency to the outside in synchronization with the emergency switch, an image management server device for receiving and storing image data from the crime prevention apparatus, and a public telephone network.

With the vehicle-mounted crime prevention apparatus and system, an inexpensive crime prevention system can be provided.

Patent Document 1: Japanese Non-Examined Patent Publication No. 2002-152341

Patent Document 2: Japanese Non-Examined Patent Publication No. 2003-319094

Patent Document 3: Japanese Non-Examined Patent Publication No. 2002-342860

### DISCLOSURE OF THE INVENTION

### Problems to be Solved by the Invention

By the way, when a person encounters a crime such as robbery, stoking, and kidnapping, it is preferred that the fact that the person has encountered a crime or is in a dangerous state is notified quickly to his/her family and/or acquaintances, the police, a private security company and so on. In addition, it is very convenient if the information about the place of the crime, the appearance of the criminal or the like can be notified together at that time. This is because accurate investigation can be performed on the basis of such the information and as a result, there is a high possibility that the criminal is arrested quickly. Moreover, to make the notification accurately at the scene of the crime, the operation necessary for the notification must be very simple. However, the above-described prior-art crime prevention apparatuses or systems are unable to fulfill such the requirements.

Specifically, with the prior-art crime prevention apparatus disclosed in Patent Document 1, the image data is created by the portable telephone and stored therein and then, they are merely transmitted to the monitor side. Therefore, the use in an emergency such as the scene where the owner (user) of the portable telephone encounters a crime is not considered.

With the prior-art crime prevention apparatus disclosed in Patent Document 2, when a housebreaker is detected, the predetermined telephone number of the next-generation type portable telephone is dialed automatically and a telephone warning is transmitted to the next-generation type portable telephone which the owner of the house possesses by way of telephone lines. The owner acquires the moving images from the camera section at the next-generation type portable telephone and judges the presence or absence of a housebreaker. Therefore, with this apparatus also, the use in an emergency such as the scene where the owner (user) of the portable telephone encounters a crime is not considered.

With the prior-art vehicle-mounted crime prevention apparatus disclosed in Patent Document 3, it is configured in such a way that the image data of the photograph of a face obtained by photographing is transmitted to the portable telephone. However, not only this apparatus is of the vehicle-mounted type but also the portable telephone merely receives the image data. Therefore, with this apparatus also, the use in an emergency such as the scene where the owner (user) of the portable telephone encounters a crime is not considered.

With the prior-art vehicle-mounted crime prevention system disclosed in Patent Document 3, the photograph of a passenger's face photographed by the portable telephone is stored in the image management server device. Thus, even if a crime actually occurs and the criminal destroys the vehicle-mounted crime prevention apparatus, effective evidence that may be used as a montage picture can be provided. However, the portable telephone merely receives the image data. Therefore, the above explanation about the prior-art vehicle-mounted crime prevention apparatus of Patent Document 3 is applicable to this system.

In addition, considering the situations where people encountered crimes, it is often that some sign or foretaste appears before a crime, although a person may encounter a crime without any signs and foretastes, such as the case that a man who wantonly knifes a passer-by. For example, with a stoking crime, a sufferer is followed by a suspicious man, mischievous calls are made many times, and so on. Even if there seems to be a high possibility that a person is implicated in a crime in the near future based on such the sign or foretaste as shown above, the police is unable to start its investigation activities before a crime occurs due to the nature of the police. Therefore, even if a concerned party senses some kind of danger and complains about his/her real picture and the danger to the police to demand police protection, it is usual that the police do not give their concrete protection activity to the party. For this reason, the words of condemnation or compassion that the crime might have been prevented if the police had coped with the complaint of the party, or the injury might have been suppressed even if the crime had not been prevented, may be sent to the police after a crime occurred.

In these cases, it is convenient for the concerned party and beneficial for the crime prevention that the information about the place where the he/she was followed by the suspicious man and the information about the picture and voice of the man who has been suspected as the stoker can be acquired and stored. This is because most of such the information as above is likely to contain the information leading to the criminal and therefore, it seems that influential evidence is able to be given to the investigation (arrest of the criminal) after a criminal occurred.

The above-described difficulties and demands are applicable in not only the cases where people encounter crimes but also the cases where people encounters accidents (e.g., traffic accident) or disasters (e.g., fire)

The present invention was created in consideration of the above-described difficulties and demands. An object of the invention is to provide a portable radio device, an emergency notification apparatus, and an emergency notification system that make it possible to notify quickly and surely the concerned persons and the related organs of a person who encounters a crime, accident or disaster (e.g., his/her family and/or acquaintances, the police, a private security company, a firehouse and so on) that the said person is in a dangerous state (a state of emergency) with a simple operation.

Another object of the present invention is to provide a portable radio device, an emergency notification apparatus, and an emergency notification system that contribute to quick arrest of a criminal and quick diagnosis of the cause when a person who encounters a crime, accident or disaster, by acquiring useful information for the investigation of the crime, accident or disaster.

Still another object of the present invention is to provide a portable radio device, an emergency notification apparatus, and an emergency notification system that enable a person who senses a danger that he/she will encounter a crime, accident or disaster to acquire and store the information that seems to be useful for the investigation of the crime, accident or disaster before he/she encounters it, and to utilize the said information for quick arrest of the criminal (solution of the case) and/or quick diagnosis of the cause if the person encounters it later.

The other objects not specifically mentioned here will become clear from the following description and attached drawings.

### Means for Solving the Problems

(1) A portable radio device according to the present invention comprises:

emergency operation starting means provided to be operable by a user in an emergency;

date and time data generating means for generating date and time data;

position measuring means for measuring a position of the portable radio device to generate position data;

photographing means for photographing an object to generate image data;

emergency processing means for performing a predetermined emergency notification process when the emergency operation starting means is operated, thereby generating emergency notification data; and

communication means for transmitting by radio the emergency notification data toward an external emergency notification apparatus along with a predetermined emergency notification signal;

wherein the emergency notification process comprises a step of generating date and time data indicating a date and time when the emergency operation starting means is operated by the date and time data generating means, a step of generating position data by measuring a position of the device when the emergency operation starting means is operated by the position measuring means, a step of generating image data by photographing an object by the photographing means when the emergency operation starting means is operated, and a step of generating the emergency notification data by adding a predetermined identification data of the device to the date

and time data, the position data, and the image data; and wherein the emergency notification signal is a signal that instructs the emergency notification apparatus to make a notification that an owner of the device is in a state of emergency to predetermined contact addresses.

(2) With the portable radio device according to the present invention, the emergency operation starting means operable by the user of the device in an emergency is provided, and when the emergency operation starting means is operated, the emergency processing means performs the predetermined emergency notification process to thereby generate the emergency notification data. Thus, if the said user operates the emergency operation starting means, the predetermined emergency notification process is immediately performed to generate the emergency notification data.

Moreover, the emergency notification process comprises the step of generating the date and time data indicating the date and time when the emergency operation starting means is operated by the date and time data generating means, the step of generating the position data by measuring the position of the device when the emergency operation starting means is operated by the position measuring means, the step of generating the image data by photographing the object by the photographing means when the emergency operation starting means is operated, and the step of generating the emergency notification data by adding the predetermined identification data to the date and time data, the position data, and the image data thus generated. Therefore, the emergency notification data contains the date and time data, the position data, and the image data, when the emergency operation starting means is operated. Then, the emergency notification data thus generated is transmitted by radio toward the external emergency notification apparatus along with the emergency notification signal that instructs the external emergency notification apparatus to make the notification that the owner of the device is in a state of emergency to the predetermined contact addresses.

For this reason, the date and time data, the position data, and the image data are delivered quickly and automatically to the external emergency notification apparatus by simply operating the emergency operation starting means by the user of the said portable radio device. Thereafter, the fact that the user of the device is in a state of emergency is notified to the predetermined contact addresses by the emergency notification apparatus.

Accordingly, if desired addresses to which an emergency notification is delivered are registered as the “contact addresses” in advance, when a person (i.e., the user of the said portable radio device) encounters a crime, accident or disaster, the fact that the person is in a dangerous state (a state of emergency) can be quickly and surely notified to the concerned persons and the related organs of the said person, such as his/her family and/or acquaintances, the police, a private security company, a firehouse and so on, with a simple operation.

Moreover, the date and time data, the position data, and the image data when the emergency operation starting means is operated are transmitted automatically to the emergency notification apparatus from the device along with the identification data of the device. Therefore, even if the portable radio device is abandoned or destroyed by the evidence destruction activities or is missing due to an incidental factor, the concerned persons and/or the related organs such as the police, a firehouse, and an accident investigation agency acquire surely the date and time data, the position data, and the image data that are effective for the investigation for the crime, accident or disaster. Accordingly, when a person encounters a crime, accident or disaster, quick arrest of the criminal and quick diagnosis of the cause can be expected by acquiring the information that are effective for the investigation for the crime, accident or disaster.

Furthermore, the portable radio device comprises the date and time data generating means, the position measuring means, and the photographing means. Therefore, even if the emergency operation starting means is not operated, the date and time data, the position data, and the image data can be generated according to the necessity and at the same time, the data thus generated may be transmitted toward the emergency notification apparatus along with the identification data of the device by the communication means. Accordingly, when the person (i.e., the user of the device) senses a danger that he/she will encounter a crime, accident or disaster, he/she can acquire the information that seems to be useful for the investigation of the crime, accident or disaster before he/she encounters it and can store the information thus acquired in the emergency notification apparatus. In addition, if the person encounters it later, the concerned persons and the related organs such as the police, a firehouse, and an accident investigation agency can utilize the stored information for quick arrest of the criminal (solution of the case) and/or quick diagnosis of the cause.

(3) With the portable radio device according to the present invention, the “emergency operation starting means” may have any configuration if the user of the device can operate it in a state of emergency. However, it is preferred that the emergency operation starting means is in the form of button or switch formed in such a way as to be exposed (or protruded) to the outside of the device. As such the switch, a mechanical switch designed to be mechanically turned on and off, or a touch switch designed to be turned on or off by a touch of a finger onto a predetermined position (which is often provided in the display screen of the device or on the outer surface thereof) may be used.

As the “date and time data generating means”, any means (which may be hardware or software or the combination of hardware and software) may be used if it can generate data that indicates a date and time.

Typically, a known circuit or electronic device that receives radio wave emitted from a GPS satellite and measures the position thereof is conveniently used as the “position measuring means”. However, the position measuring means is not limited to this. The position measuring means may have any configuration (which may be hardware or software or the combination of hardware and software) if it can generate the position data by measuring the position of the portable radio device.

As the “photographing means”, typically, a known digital camera built in a portable telephone may be conveniently used. However, the photographing means is not limited to this. The photographing means may have any configuration (which may be hardware or software or the combination of hardware and software) if it can generate the image data by photographing an object.

It is sufficient that the “emergency processing means” performs a predetermined emergency notification process to generate the emergency notification data when the emergency operation starting means is operated. Since the emergency notification process includes the above-described steps, it may be presumed that the emergency processing means is easily realized with software. However, the emergency processing means is not limited to this. The emergency processing means may be realized with hardware or the combination of hardware and software.

As the “communication means”, any configuration (which may be hardware or software or the combination of hardware and software) may be used if it can transmit by radio the emergency notification data toward the external emergency notification apparatus along with the predetermined emergency notification signal. Typically, known radio communication device or known software for radio communication may be used for the communication means.

As the “emergency notification signal”, any signal may be used if it instructs the emergency notification apparatus to make a notification that the owner of the portable radio device is in a state of emergency to the predetermined contact addresses. For example, the emergency notification signal can be easily realized by defining a specific code as the “emergency notification signal” in advance and by transmitting the said code along with the emergency notification data.

(4) In a preferred embodiment of the portable radio device according to the present invention, a sound collecting microphone, and a sound processing means for processing sound collected by the microphone to generate sound data are further provided, wherein when the emergency operation starting means is operated, sound is collected by the microphone and sound data is generated, and wherein the sound data is included in the emergency notification data. In this case, since the sound data from the neighborhood of the portable radio device at which the emergency operation starting means is operated are further obtained, the quantity of the information available for the investigation of the crime, accident or disaster is increased. As a result, there is an additional advantage that the expectation for quick arrest of the criminal and quick diagnosis of the cause becomes higher.

In another preferred embodiment of the portable radio device according to the present invention, a sound collecting microphone, and a sound processing means for processing sound collected by the microphone to generate sound data are further provided, wherein the sound processing means performs voice or speech recognition using the sound data to judge whether the emergency notification process is necessary or not, and wherein if the sound processing means judges that the emergency notification process is necessary, the sound processing means causes the emergency processing means to perform the emergency notification process. In this case, there is an additional advantage that emergency notification is surely performed even if the user of the portable radio device is unable to operate the emergency operation starting means despite the user being in a dangerous situation.

In still another preferred embodiment of the portable radio device according to the present invention, contact address storing means for storing contact address data indicating the contact addresses is further provided, wherein in the emergency notification process, the contact address data stored in the contact address storing means is read out and then, included in the emergency notification data. In this case, there is an additional advantage that emergency notification can be performed to desired contact addresses even if the contact addresses are not designated in the emergency notification apparatus in advance.

In a further preferred embodiment of the portable radio device according to the present invention, the contact address data indicating the contact addresses is not included in the emergency notification data. In this case, the contact address data is stored in the emergency notification apparatus, and the notification is carried out by reading out the contact address data from the emergency notification apparatus. As a result, there is an additional advantage that communication speed is raised and communication error is decreased because the total quantity of the emergency notification data is decreased.

In a still further preferred embodiment of the portable radio device according to the present invention, the emergency processing section has a function of generating an accumulation data by adding the identification data of the portable radio device to the date and time data generated by the date and time data generating means, the position data generated by the position measuring means, and the image data generated by the photographing means, and of transmitting the accumulation data thus generated toward the emergency notification apparatus by the communication means. In this case, when the user of the portable radio device senses a danger that he/she will encounter some crime, accident or disaster, he/she can photographs an object by the photographing means to generate image data before encountering with it and then, links the image data thus generated with the date and time data and the position data obtained at the time of photographing, thereby generating the accumulation data. As a result, there is an additional advantage that the said user can acquire the information that seems to be useful for the investigation of the crime, accident or disaster and store the information thus acquired in the emergency notification apparatus, which is realizable without providing dedicated means separately.

In a still further preferred embodiment of the portable radio device according to the present invention, the communication means transmits the emergency notification data and the emergency notification signal toward the emergency notification apparatus by way of a plurality of paths. In this case, since the situation (transmission error) where the emergency notification apparatus is unable to receive the emergency notification data and the emergency notification signal is difficult to occur, there is an additional advantage that the certainty that the notification is performed by the emergency notification apparatus raised furthermore.

(5) An emergency notification apparatus according to the present invention, which is designed to receive and store emergency notification data transmitted from outside and to receive an emergency notification signal transmitted with the emergency notification data and perform a predetermined emergency notification process, comprises:

authentication means for judging whether a sender of the emergency notification data is an authorized person or not by extracting identification data from the emergency notification data and verifying the identification data thus extracted;

signal detection means for judging whether the emergency notification signal is received or not along with the emergency notification data;

database management means for extracting, from the emergency notification data, date and time data, and position data and image data linked with the date and time data, and for storing the date and time data, the position data, and the image data thus extracted in a database in such a way as to have a relation with the identification data; and

notification means for performing a notification that the sender of the emergency notification data is in a state of emergency to predetermined contact addresses by performing the emergency notification process when the signal detection means judges the emergency notification signal is received.

(6) With the emergency notification apparatus according to the present invention, after receiving the emergency notification data transmitted from the outside, the identification data is extracted from the emergency notification data thus received and verified it by the authentication means, thereby judging whether the sender of the emergency notification data is an authorized person for the use of the emergency notification apparatus or not. As a result, if it is judged that the sender is an authorized person, the date and time data, and the position data and the image data linked with the date and time data are extracted from the emergency notification data and then, the date and time data, the position data, and the image data thus extracted are stored in the database in such a way as to have the relation with the identification data by the database management means.

On the other hand, whether the emergency notification signal is received or not along with the emergency notification data is judged by the signal detection means. As a result, if it is judged that the emergency notification signal is received, the predetermined emergency notification process is performed by the notification means. Thus, a notification that the sender of the emergency notification data is in a state of emergency is performed to the predetermined contact addresses

If it is judged that the emergency notification signal is not received by the signal detection means, the emergency notification process is not performed. In this case, it is preferred that the date and time data, the position data, and the image data are extracted from the emergency notification data and then, the date and time data, the position data, the and image data thus extracted are stored in the database in such a way as to have the relation with the identification data by the database management means. However, such the data storing operation may be cancelled.

(7) With the emergency notification apparatus according to the present invention, it is sufficient that the “emergency notification data” includes the identification data for judging whether the sender of the emergency notification data is the authorized person for the use of the said apparatus or not, the date and time data that indicates the date and time at which the state of emergency has occurred to the sender, and the position and image data linked with the date and time data.

As the “emergency notification signal”, any signal may be used if it instructs that a notification that the sender of the emergency notification signal is in a state of emergency is performed to predetermined contact addresses. For example, the “emergency notification signal” can be easily realized by defining a specific code as the “emergency notification signal” in advance and by receiving the said code along with the emergency notification data.

As the “emergency notification process”, any process may be used if it can make a notification that the sender of the emergency notification data is in a state of emergency is performed to predetermined contact addresses. For example, a process of sending a predetermined message orally or by documents or by text data to previously designated telephone numbers, facsimile numbers, electronic mail addresses and so on may be used for this purpose.

It is sufficient that the “authentication means” can judge whether the sender of the emergency notification data is the authorized person for the use of the emergency notification apparatus or not by extracting the identification data from the emergency notification data and verifying the identification data thus extracted. If it satisfies this condition, the authentication means may be realized by hardware or the combination of hardware and software.

Typically, the authentication means may be realized by software. For example, the authentication means may be realized easily by designating a specific code as the “identification data” in advance and examining whether the said code is included in the emergency notification data or not with software.

It is sufficient that the “signal detection means” can judge whether the emergency notification signal is received or not along with the emergency notification data. If it satisfies this condition, the signal detection means may be realized by hardware or the combination of hardware and software. Typically, the signal detection means may be realized by software. For example, the signal detection means may be realized easily by designating a specific code as the “emergency notification signal” in advance and examining whether the said code is received or not by software.

It is sufficient that the “database management means” can extracts the date and time data, and the position data and image data linked with the date and time data from the emergency notification data, and can store the date and time data, the position data, and the image data thus extracted in the database in such a way as to have a relation with the identification data. If it satisfies this condition, the database management means may be realized by hardware, software, or the combination of hardware and software. Typically, the database management means may be easily realized by combining a known database management software with a known computer.

It is sufficient that the “notification means” performs a notification that the sender of the emergency notification data is in a state of emergency to the predetermined contact addresses by performing the emergency notification process. If it satisfies this condition, the notification means may be realized by hardware, software, or the combination of hardware and software. For example, when telephone or facsimile numbers are designated as the contact addresses, a predetermined message can be transmitted to the contact addresses orally or by document by a known communication software. When electronic addresses are designated as the contact addresses, a predetermined message can be transmitted in the form of text data to the contact addresses if a known mail server and other electronic mail management software is used.

(8) In a preferred embodiment of the emergency notification apparatus according to the present invention, the emergency notification data includes sound data. In this case, since the sound data is obtained in addition to the date and time data, the position data, and the image data, the quantity of the information available for investigation of the crime, accident or disaster is increased. As a result, there is an additional advantage that the expectation for quick arrest of the criminal and quick diagnosis of the cause becomes higher.

In another preferred embodiment of the emergency notification apparatus according to the present invention, the emergency notification data includes contact address data indicating the contact addresses. In this case, there is an additional advantage that emergency notification to desired contact addresses can be performed without designating the contact addresses in the said apparatus in advance.

In still another preferred embodiment of the emergency notification apparatus according to the present invention, the contact address data indicating the contact addresses is stored in the database in such a way as to have a relation with the identification data, and the notification is performed after reading out the contact address data from the database. In this case, there is an additional advantage that communication speed is raised and communication error is decreased because the total quantity of the emergency notification data is decreased

In a further preferred embodiment of the emergency notification apparatus according to the present invention, when it is judged by the signal detection means that the emergency notification signal is received, a callback is performed to the sender of the emergency notification data. In this case, there is an additional advantage that if the sender of the emergency notification data is in a state where he/she can make a response, the situation can be confirmed on the spot, and that if no response is received from the sender of the emergency notification data, it may be presumed that the sender of the emergency notification data is in a situation where he/she is unable to make a response.

In a still further preferred embodiment of the emergency notification apparatus according to the present invention, when a predetermined period passes from a time when the date and time data, the position data, and the image data extracted from the emergency notification data are stored in the database in such a way as to have the relation with the identification data, the database management means eliminates from the database the date and time data, the position data, and the image data thus extracted and moves them to a data storage file. In this case, there is an additional advantage that the total quantity of the stored data in the database is decreased and the retrieval speed is improved. On the other hand, since the data thus eliminated from the database is stored in the data storage file, the said data can be utilized by retrieving the data storage file when they are required in the future.

### (9) An emergency notification system according to the present invention comprises the above-described portable radio device according to the invention and the above-described emergency notification apparatus according to the invention.

### ADVANTAGEOUS EFFECTS OF THE INVENTION

With the portable radio device, the emergency notification apparatus, and the emergency notification system according to the present invention, when a person encounters a crime, accident or disaster, the concerned persons and/or the related organs of the said person such as his/her family and/or acquaintances, the police, a private security company, and a firehouse can be notified quickly and surely that the said person is in a dangerous state (a state of emergency) with a simple operation. Moreover, when a person encounters a crime, accident or disaster, the information that are useful for the investigation of the crime, accident or disaster can be acquired to thereby give contribution to quick arrest of the criminal and/or quick diagnosis of the cause. Furthermore, when a person senses a danger that he/she will encounter a crime, accident or disaster, the information that seems to be useful for the investigation of the crime, accident or disaster can be acquired and stored before he/she encounters it, and the information thus stored can be used for quick arrest of the criminal (solution of the case) and/or quick diagnosis of the cause if the person encounters it later.

### BRIEF DESCRIPTION OF THE DRAWINGS

FIG. 1 is a conceptual diagram showing the configuration of an emergency notification system according to a first embodiment of the invention.

FIG. 2 is a view showing the appearance of a portable radio device used in the emergency notification system according to the first embodiment of the invention.

FIG. 3 is a functional block diagram showing the internal structure of the portable radio device used in the emergency notification system according to the first embodiment of the invention.

FIG. 4 is an explanatory diagram showing the processing status of the respective data, signals, and messages used in the emergency notification system according to the first embodiment of the invention.

FIG. 5 is a functional block diagram showing the internal structure of the emergency notification system according to the first embodiment of the invention and the emergency notification apparatus used in the said system.

FIG. 6 is a flowchart showing the operation of the portable radio device used in the emergency notification system according to the first embodiment of the invention.

FIG. 7 is a flowchart showing the operation of the emergency notification apparatus used in the emergency notification system according to the first embodiment of the invention.

FIG. 8 is an explanatory diagram showing the processing status of the respective data, signals, and messages used in the emergency notification system according to the first embodiment of the invention.

FIG. 9 is an explanatory diagram showing an example of the emergency notification file and the authentication data used in the emergency notification system according to the first embodiment of the invention.

FIG. 10 is a view showing the appearance of a portable radio device used in an emergency notification system according to a second embodiment of the invention.

FIG. 11 is a view showing the appearance of a portable radio device used in an emergency notification system according to a third embodiment of the invention.

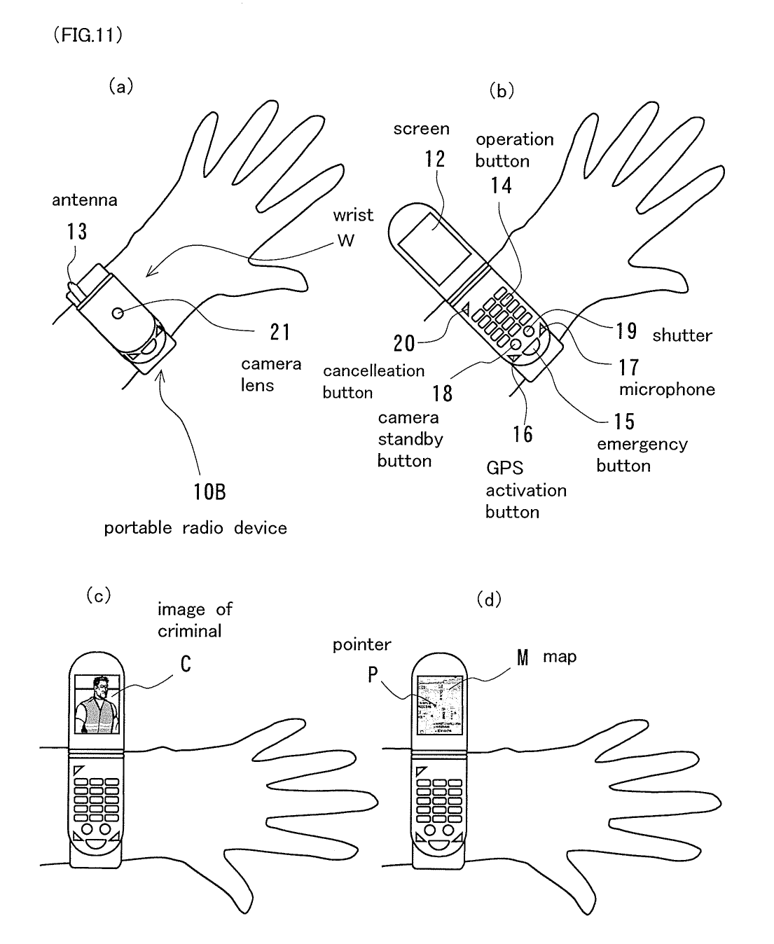

### DESCRIPTION OF THE REFERENCE SYMBOLS

10, 10′, 10A, 10B portable radio device
11 body
12 screen
13 antenna
14 operation button
15 emergency button
16 GPS activation button
17 microphone
18 camera standby button
19 shutter
20 cancellation button
21 camera lens
31 clock section
32 digital camera section
33 display section
34 current position measuring section
35 position data storing section
36 contact address data storing section
37 image data storing section
38 image processing section
39 communication section
40 sound processing section
41 control section
42 sound data storing section
43 emergency processing section
50, 50A, 50B base station
60 Internet
70 emergency notification apparatus
80 GPS satellite
101 firewall
102 remote access server (RAS)
103 router
104 authentication server
105 authentication database
106 database server
107 notification data storing database
108 mail server
109 computer
110 data storage file
200 public telephone line
201 portable radio device
202 fixed telephone
203 facsimile
204 computer
C image of a criminal
M map
P pointer

### BEST MODE FOR CARRYING OUT THE INVENTION

Preferred embodiments of the present invention will be described in detail below while referring to the drawings attached.

### Entire Configuration of Emergency Notification System According to First Embodiment

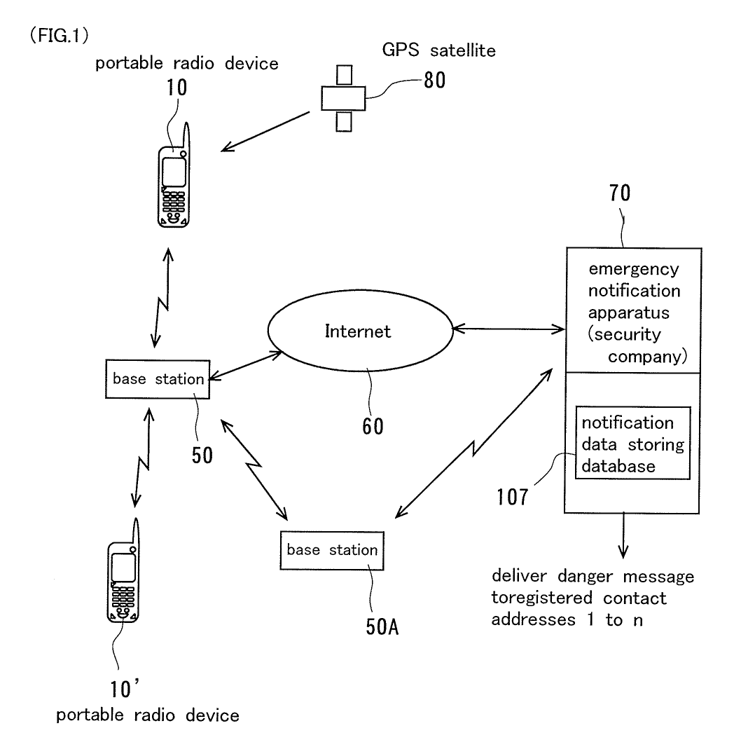

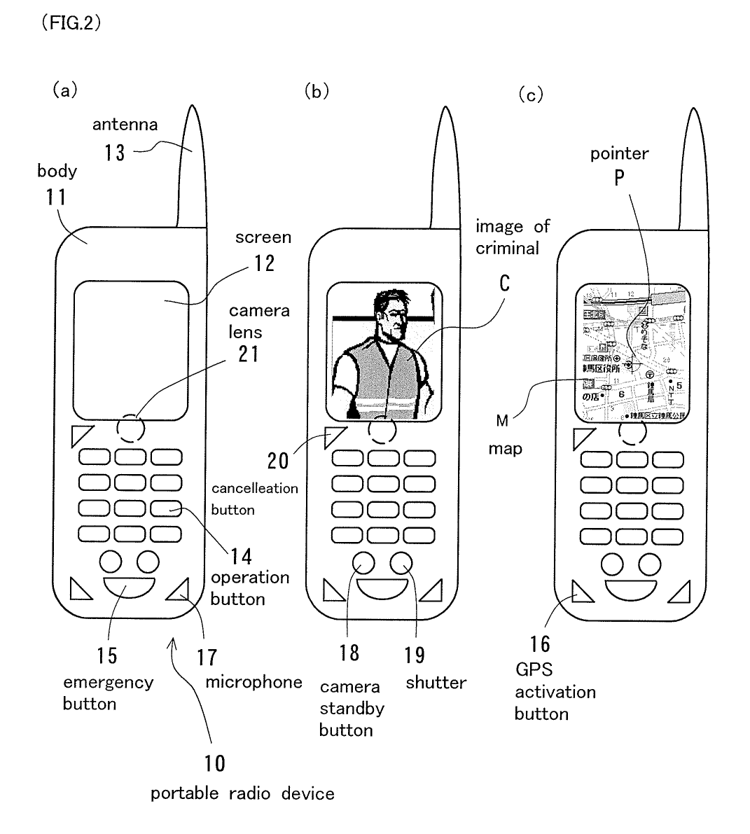

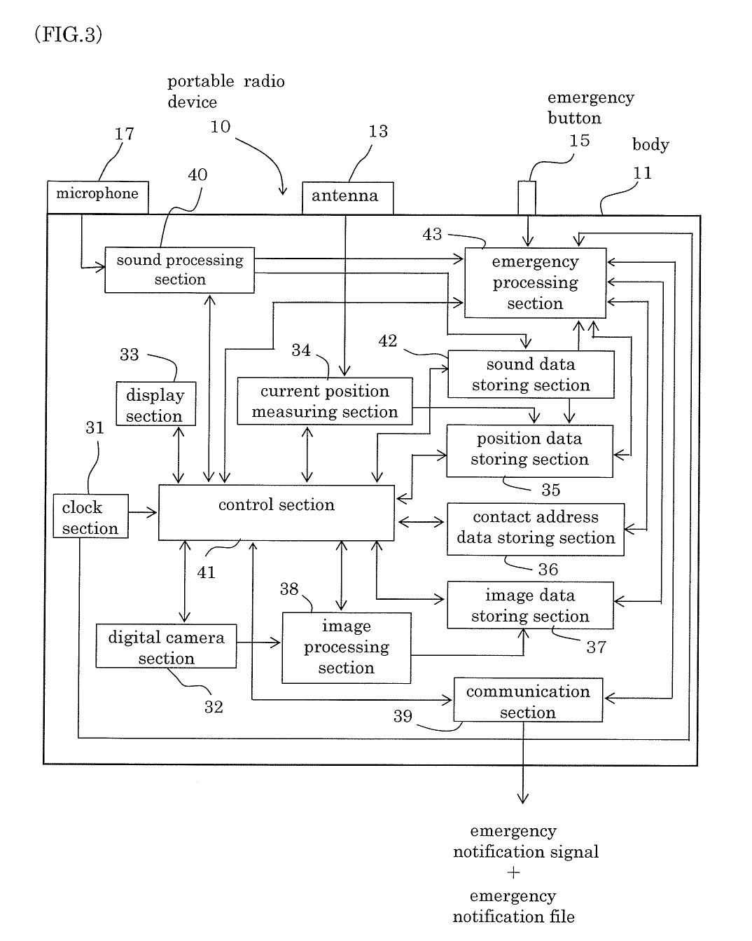

FIG. 1 is a conceptual diagram showing the configuration of an emergency notification system using a portable radio device according to a first embodiment of the invention, FIG. 2 is a view showing the appearance of the portable radio device, and FIG. 3 is a functional block diagram showing the internal structure of the portable radio device.

As shown in FIG. 1, the emergency notification system according to the first embodiment of the invention comprises a portable radio device 10, and an emergency notification apparatus 70 installed in the building of a private security company.

When an emergency notification signal and an emergency notification file are transmitted from the portable radio device 10, the emergency notification signal and the emergency notification file are delivered to the emergency notification apparatus 70 by way of a base station 50 constituting a portable or mobile telephone network, and the Internet 60. The apparatus 70 responds immediately to the emergency notification signal to send predetermined danger massages to the contact address 1 to the contact address n (n is an integer equal to or greater than 2) registered in advance, thereby quickly notifying that a dangerous situation (a state of emergency) has occurred for the user (owner) of the device 10. The apparatus 70 stores the respective data contained in the emergency notification file thus delivered in a built-in database 107 for storing the notification data. In this way, the respective data stored in the database 107 become available for the investigation of crime, accident or disaster as necessary.

The emergency notification signal and the emergency notification file transmitted from the portable radio device 10 may be reached the emergency notification apparatus 70 by way of the portable telephone network including the base station 50 and a base station 50A without routing through the Internet 60. In this case also, the apparatus 70 stores the respective data in the emergency notification file in the notification data storing database 107.

### Portable Radio Device Used in Emergency Notification System According to First Embodiment

Next, the detailed configuration of the portable radio device 10 according to the first embodiment of the invention will be explained with reference to FIGS. 2 and 3.

As shown in FIG. 2, the portable radio device 10 is structured as a portable or mobile telephone and has a well-known formation and functions. Thus, as shown in FIG. 1, the device 10 can make speech communication with another portable radio device 10′ with a similar structure or a fixed telephone (not shown) by way of the base station 50. In addition, the device 10 can be connected to the Internet 60 by radio with the built-in electronic circuit (not shown) for Internet connection and then, view the websites placed on the Internet 60 and transmit or receive electronic mails via the Internet 60. This means that the device 10 comprises the Internet connection function and the electronic mail transmission/reception function in addition to the ordinary speech communication function. These functions and the means for realizing them are well known and therefore, detailed explanations for them are omitted here.

The portable radio device 10 shown in FIG. 2 has the following additional functions.

First, there are provided with the functions of photographing a desired object with a built-in digital camera (not shown) and storing the image data thus obtained, of transmitting the said image data to the outside through the Internet 60 (or, not through the Internet 60), and of receiving image data from the outside through the Internet 60 (or, not through the Internet 60).

Second, there is provided with the function of receiving radio wave emitted from a GPS satellite 80 (see FIG. 1) to obtain the position information, and of measuring the current position of the portable radio device 10 based on the position information thus obtained to display the current position.

Third, there is provided with the function of collecting sound with a built-in microphone 17 for speech communication, perceiving whether the sound thus collected is the same as a predetermined sound (e.g., the scream or voice for help of the owner of the portable radio device 10 stored previously) or not, and performing a predetermined emergency notification operation if the collected sound is judged the same as the predetermined sound. For example, if it is perceived that the collected sound is a voice for help or a scream of a person, it is judged that a state of emergency has occurred to the person and a predetermined emergency notification operation is started.

The first “photographing function” can be easily realized by using the same means as that of a portable telephone having a digital camera that is actually put on the market and used. The second “position measuring function” can be easily realized by using the same means as that of a PDA, portable data terminal or the like having a GPS position measuring function that is actually put on the market and used. The third “voice recognition function” can be easily realized by using the same software as known voice recognition software that is actually put on the market and used or hardware that realizes the equivalent function thereto. Accordingly, detailed explanations for these means are omitted here.

The portable radio device 10 comprises a thin box-shaped body 11. On the surface of the body 11, as shown in FIG. 2, an approximately rectangular screen 12 is provided, which is formed by a liquid-crystal display device. On the screen 12, various characters and images, such as the menu images for operation, texts for electronic mail that are to be transmitted or that have been received, characters and pictures in the websites, images of objects that are to be photographed or that have been photographed, maps based on the GPS function and the pointer indicating the current position of the portable radio device 10 can be displayed as necessary.

At the top of the body 11, an antenna 13 is mounted. The antenna 13 is chiefly used for speech communication; however, it is used for connection to the Internet 60, data communication (e.g. transmission/reception of data, or transmission/reception of electronic mail) by way of the Internet 60, and reception of radio wave emitted from the GPS satellite 80.

At the approximately center of the back of the body 11, a lens 21 of the built-in digital camera is attached in such a way as to be exposed from the body 11. If the lens 21 is pointed at an object to be photographed, the image of the object is displayed on the screen 12. Therefore, the object can be photographed while verifying the position and size of the object. Since the image of the object thus photographed is stored in the built-in memory and displayed immediately on the screen 12, whether the photographing is good or not can be checked on the spot.

On the surface of the body 11, a group of buttons 14 for telephone operation (i.e., power on/off button, numeric character buttons of 0 to 9, and other buttons for additional functions), an emergency button 15, a GPS activation button 16, a microphone 17, a camera standby button 18, a shutter 19 for the built-in digital camera, and a reset button 20 are provided. In addition, although a speaker for speech communication is provided on the surface of the body 11, it is not shown. This is because this speaker does not relate to the present invention.

The group of buttons 14 is the same as that provided on a well-known portable or mobile telephone.

The emergency button 15 is provided to instruct the start of the emergency notification operation explained later to the emergency notification apparatus 70. It is configured that the predetermined emergency notification operation (the details are to be described later) will be started if the button 70 is pressed.

The GPS activation button 16 is provided to set the built-in GPS reception circuit (not shown) active or inactive. If this button 16 is pressed, the GPS reception circuit is turned into the active state. In this state, the radio wave (which includes the position information) emitted from the GPS satellite 80 is received by the antenna 13 and then, the current position is measured based on the position information received and displayed on the screen 12. To turn the GPS reception circuit into the inactive state, it is sufficient to press the button 16 again.

The microphone 17 is a device for picking up the sound in its neighborhood and for converting it to electric signal. Although the microphone 17 is chiefly used for speech communication, it is used for sound collection as necessary even if speech communication is not performed. For example, the microphone 17 is used for voice recognition to judge whether the emergency notification is necessary or not, or for picking up the sound in the neighborhood in a state of emergency.

The camera standby button 18 is provided to set the built-in digital camera active or inactive. If this button 18 is pressed, the built-in digital camera is activated to be capable of photographing, where an object can be photographed by pressing (operating) the shutter 19. The image of the object thus photographed is stored in the memory (not shown) mounted in the portable radio device 10 as digital image data. The image data thus stored can be transmitted to the outside through the Internet 60 (or not through the Internet 60) as necessary, and image data can be received from the outside through the Internet 60 (or not through the Internet 60) and stored in the said memory. To turn the digital camera into the inactive state, it is sufficient to press the button 18 again.

The cancellation button 20 is provided to cancel a false operation generated by operating the emergency button 15 in error. Specifically, this button 20 is to instruct the stop or interruption of the emergency notification operation which will start upon the operation of the emergency button 15. This is based on the consideration for the following situation. There is a possibility that although the user of the portable telephone device 10 presses the emergency button 15 because of some kind of danger, he/she finds it misunderstanding later and has a desire to cancel the emergency notification operation.

FIG. 2(a) shows the waiting state of the portable radio device 10. At this time, it is usual that a predetermined waiting image or initial menu is displayed on the screen 12; however, it is omitted here. FIG. 2(b) shows the operating state of the built-in digital camera. In FIG. 2(b), an image C of the criminal, which was photographed by the said digital camera, is displayed on the screen 12. FIG. 2(c) shows the operating state of the GPS function. In FIG. 2(c), a map M and a pointer P indicating the current position of the device 10 are displayed on the screen 12. In this way, a variety of images is displayed on the screen 12 as necessary.

FIG. 3 is a functional block diagram showing the configuration of the internal circuits of the body 11 of the portable radio device 10.

As shown in FIG. 3, there is provided with a clock section 31, a digital camera section 32, a display section 33, a current position measuring section 34, a position data storing section 35, a contact address storing section 36, an image data storing section 37, an image processing section 38, a communication section 39, a sound processing section 40, a control section 41, a sound data storing section 42, and an emergency processing section 43 in the body 11. The control section 41 controls the entire internal circuits of the body 11. The position data storing section 35, the contact address storing section 36, the image data storing section 37, and the sound data storing section 42 are formed by partitioning a single piece of hardware (memory) for the respective sections; however, needless to say, these sections 35, 36, 37 and 42 may be formed by separate pieces of hardware (memories).

The clock section 31 supplies a predetermined clock signal to the control section 41 and necessary time data to the emergency processing section 43.

While the built-in digital camera is in the active state by pressing the camera standby button 18, the digital camera section 32 photographs an object via the camera lens 21 in response to the operation of the shutter 19, generates digital image data corresponding to the object thus photographed, and sends the image data to the image processing section 38. The image processing section 38 applies predetermined data processes such as data compression to the image data thus sent and stores it in the image data storing section 37. Although the digital camera section 32 and the image processing section 38 perform respectively the same operations as those explained here when the emergency button 15 is pressed also, this is independent of whether the camera standby button 18 has been pressed or not when the emergency button 15 is pressed. These operations are carried out under the control of the control section 41.

The display section 33, which is a section for controlling the images displayed on the screen 12, displays any image such as the above-described menu and waiting image on the screen 12 as necessary.

Under the control of the control section 41, the current position measuring section 34 receives the GPS radio wave emitted from the GPS satellite 80 by the antenna 13, measures the current position of the portable radio device 10 using the position information included in the GPS radio wave, and generates the position data indicating the current position of the device 10. The position data thus generated is stored in the position data storing section 35. The current position measuring section 34 performs the same operations as those described here when the emergency button 15 is pressed also.

The contact address storing section 36 is a section for storing the data indicating the contact addresses (e.g., fixed telephone number, portable telephone number, electronic mail address, facsimile number and so on) to which a predetermined “danger message” (e.g., Mr./Ms. AA is in danger, or Mr./Ms. BB is in a dangerous state) is to be sent. The contact address stored in the section 36 is termed the “registered contact address” here. M contact addresses can be registered or stored in the section 36, where m is a positive integer equal to or greater than 2 and m>n.

The contact address data is usually inputted (or registered) by manipulating the operation buttons 14 by the user of the portable radio device 10. However, the contact address data may be brought in for registration by using an electronic mail, a portable memory device or the like from the outside. Moreover, the registered contact address data can be changed or deleted in the same way. These operations are performed under the control of the control section 41.

It is preferred that the contact address data stored in the contact address storing section 36 is transmitted to the emergency notification apparatus 70 and stored in the notification data storing database 107 every time the input or registration of the said data is completed. Moreover, it is preferred that when the contact address is changed or deleted, it is immediately transmitted to the emergency notification apparatus 70 to reflect the change or deletion in the content of the database 107. If so, transmission of the contact address data to the apparatus 70 is unnecessary when an emergency notification is made and therefore, the quantity of the data to be transmitted is decreased. As a result, there is an advantage that the transmission speed and the certainty of transmission are raised. In addition, it is unnecessary that the contact address data is stored in the database 107 in advance. In this case, it is necessary that the contact address data also is transmitted to the apparatus 70 when an emergency notification is made.

Under the control of the control section 41, the sound processing section 40 data-processes the sound that was collected by the microphone 17 and converted to an electric signal, and stores the sound data thus generated in the sound data storing section 42. Moreover, this section 40 recognizes whether the sound data thus obtained is the same as the previously registered voice for help of the owner (user) of the portable radio device 10 or not, or the previously registered scream of the said owner (user) or not. If the section 40 judges that the sound data is the same as the registered voice or scream, the section 40 sends a predetermined activation signal to the emergency processing section 43, thereby activating the section 43. As a result, the emergency processing section 43 performs the predetermined emergency notification process in the same way as that in the case where the emergency button 15 is pressed.

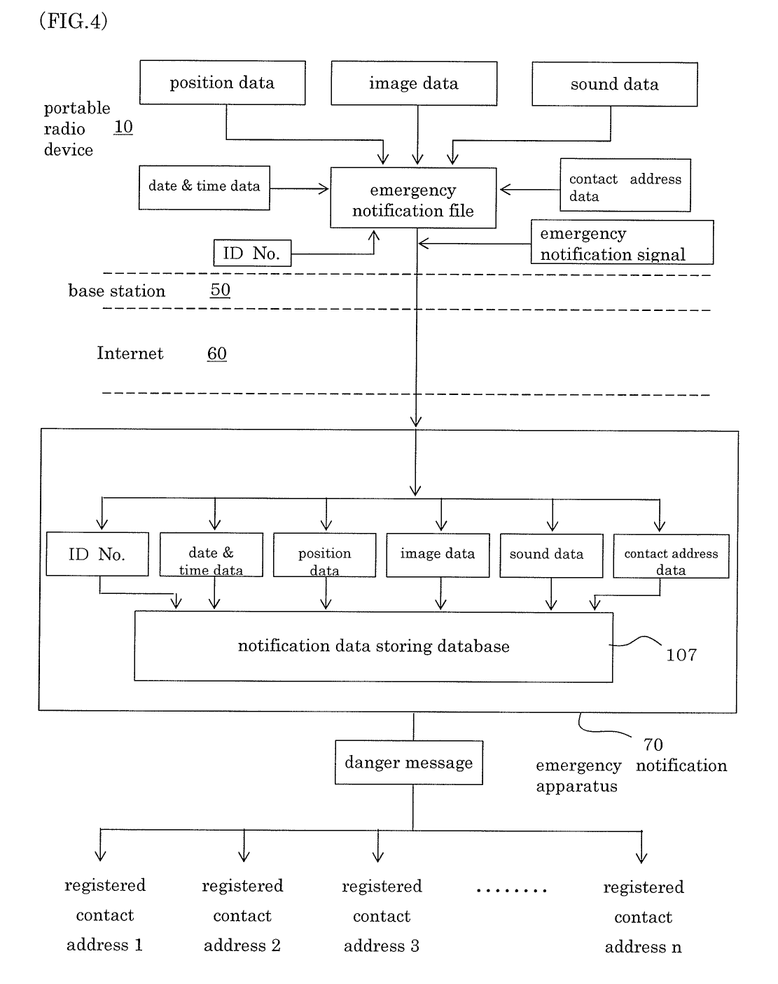

When the emergency button 15 is pressed or the activation signal is sent from the sound processing section 40 (which is termed the “emergent time”), the emergency processing section 43 detects it and performs the predetermined “emergency notification process”. The “emergency notification process” means the following sub-processes (1) to (8). (See FIG. 4). In addition, since each of these sub-processes (1) to (8) can be easily realized by using the known prior-art techniques, for example, by adjusting the control program in the control section 41, explanation about them in more detail than presented below is omitted here.

### (1) To receive the date and time data indicating the date and time of the “emergent time” sent from the clock section 31.

### (2) To measure the current position at the “emergent time” by the current position measuring section 34, to store the position data thus obtained in the position data storing section 35, and to read out the position data from the section 35.

### (3) To obtain the image of the object at the “emergent time” by photographing with the digital camera section 32, to store the image data thus obtained in the image data storing section 37, and to read out the image data from the section 37.

(4) To collect the sound at the “emergent time” by the microphone 17, to data-process the sound data thus obtained by the sound processing section 40, to store the sound data thus obtained in the sound data storing section 42, and to read out the sound data from the section 42.
(5) To read out the contact address data from the contact address data storing section 36. (If it is set in such a way that the contact address data is transmitted to the emergency notification apparatus 70 and stored in the notification data storing database 107 in advance, and the stored contact address is read out from the database 107 and used in an emergency, this operation is unnecessary.)
(6) To generate the “emergency notification file” by combining the “ID (Identification) number” of the owner (user) of the portable radio device 10 with the date and time data, the position data, the image data, the sound data, and the contact address data obtained in the sub-processes (1) to (5). At this time, the position data, image data, sound data and contact address data are linked with the date and time data. This is to designate that the position data, image data, sound data and contact address data were obtained at the date and time indicated by the data and time data. In addition, it is preferred that these data are compressed by a known appropriate method to decrease the total data amount in this sub-process. In this case, this data compression operation is carried out by the emergency notification section 43.

### (7) To add the predetermined “emergency notification signal” to the “emergency notification file” generated in (6) and send the said “emergency notification file” to the communication section 39.

The “emergency notification signal” added to the “emergency notification file” is a signal that instructs the emergency notification apparatus 70 to perform the predetermined emergency notification operation. Concretely speaking, the “emergency notification signal” instructs the apparatus 70 placed in the private security company to send the predetermined “danger message” (e.g., Mr./Ms. AA is in danger, or Mr./Ms. BB is in a dangerous state) to the previously registered contact addresses 1 to n by the means such as telephone, electronic mail, facsimile or the like.

The “ID number” included in the “emergency notification file”, which is the peculiar discrimination number that the owner (user) of the portable radio device 10 possesses, is given by the private security company where the emergency notification apparatus 70 is placed. After receiving the “ID number” from the company, the owner (user) of the device 10 can utilize the emergency notification service using the apparatus 70.

(8) To transmit by radio the “emergency notification file” and the “emergency notification signal” sent in (7) to the outside by the communication section 39. The “emergency notification file” and the “emergency notification signal” thus transmitted will arrive at the emergency notification apparatus 70 by way of the base station 50 and the Internet 60 on one hand. On the other hand, the “emergency notification file” and the “emergency notification signal” will arrive at the apparatus 70 by way of only the base stations 50 and 50A (i.e., the portable telephone network) (not through the Internet 60). This is to raise the certainty of arrival (safety) of the “emergency notification file” and the “emergency notification signal”. However, needless to say, if desired certainty of arrival (safety) is obtainable, it may be configured such that they arrive at the apparatus 70 through one of these two paths. Moreover, it may be configured such that they arrive at the apparatus 70 through three or more paths.

As explained above, if the emergency notification file is generated from the group of the inputted data, the emergency notification signal is added to the emergency notification file, and the emergency notification file and the emergency notification signal added thereto are transmitted to the emergency notification apparatus 70, the predetermined danger message is transmitted to the registered contact addresses 1 to n. The data flow in these processes is shown in FIGS. 4 to 8.

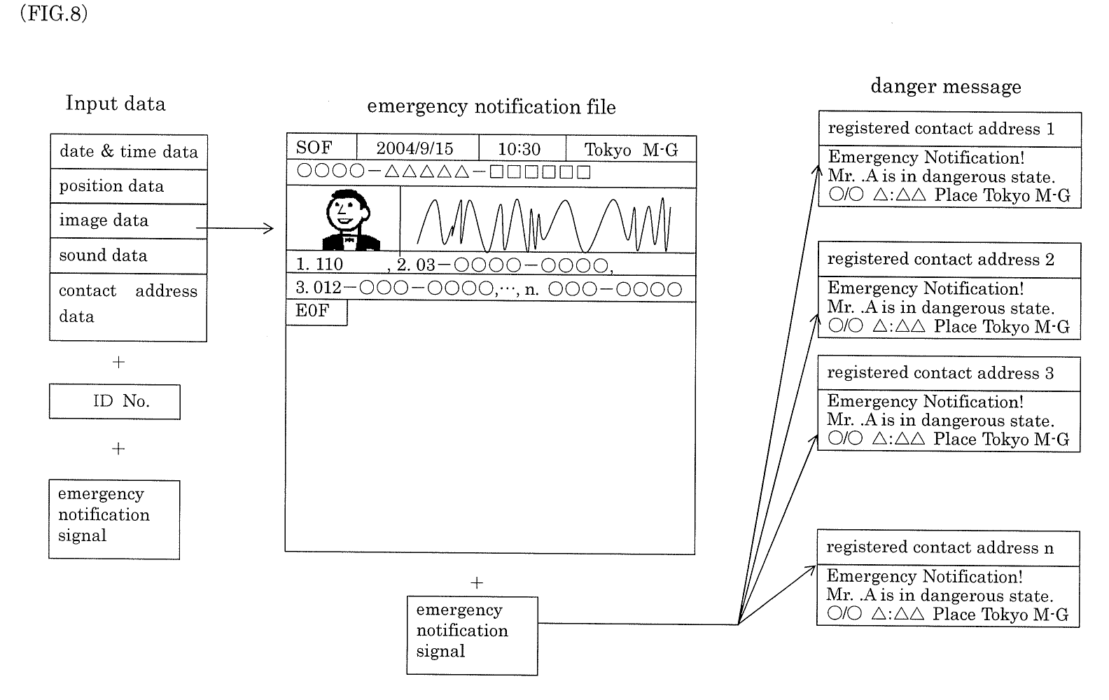

In an example of the emergency notification file shown in FIG. 8, this file contains the date and time data of “2004/9/15” and “10:30”, the position data of “Tokyo M-G” (where M-G means the previously designated regional code of Tokyo), the ID number of “XXXX-YYYYY-ZZZZZZ”, the image data of the picture of a person's face, the sound data indicated by waveforms, and the contact address data. These data are arranged from the upper left to lower right of the file between the top of the file (Start Of File, SOF) and the end thereof (End Of File, EOF). In addition, the position data is not limited to such the regional code representation as shown here and it may be represented by latitude and longitude, or domicile notation. The position data may be represented any form if it can designate desired positions.

The “transmission flag” in the emergency transmission file shown in FIG. 8 is a code for verifying whether the danger message has been sent to each of the n registered contact addresses 1 to n. The initial value is “0”, and “1” is added thereto every time the danger message has been sent to each of the registered contact addresses 1 to n. If the value of the “transmission flag” is equal to “n”, it is found that the danger message has been sent to all the registered contact addresses 1 to n. In this way, by using the “transmission flag”, there is an advantage that the state of the danger message being successively sent to the respective contact addresses 1 to n can be monitored.

Taking the emergent time into consideration, the above-described sub-processes (1) to (4) are always performed at the emergent time regardless of whether the digital camera section 32, the current position measuring section 34, and/or the sound processing section 40 is/are in the active state or not. For this reason, the position, image, and sound data at the emergent time can be acquired with reliability.

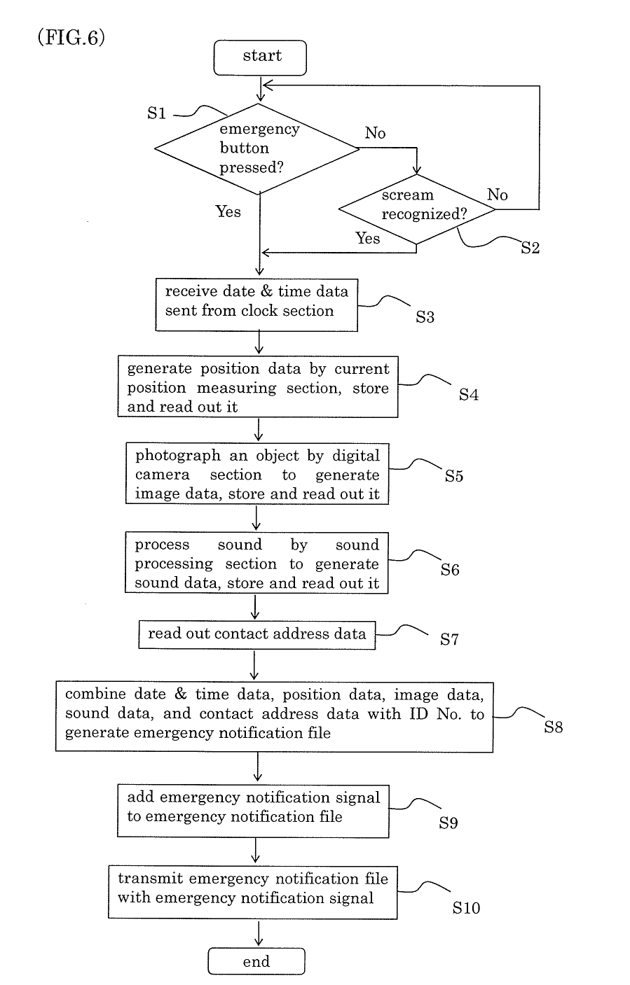

FIG. 6 is a flowchart showing the operation of the portable radio device 10. The operation of the device 10 will be explained below with reference to FIG. 6. In the following operations, if the subject of an operation is not shown explicitly, the said operation is performed by the emergency notification section 43.

In the step S1, whether the emergency button 15 is pressed or not is judged. If the result is “Yes”, the flow advances to the step S3. If the result is “No”, the flow goes to the step S2, where the predetermined scream (or voice) is recognized or not is judged by the sound processing section 40. If the result of the step S2 is “No”, the flow returns to the Step S1, where the above-described judgment is judged again. If the result of the step S2 is “Yes”, the flow advances to the Step S3. In this way, with the portable radio device 10, whether the “emergency notification process” should be started or not is always monitored in the steps S1 and S2. Therefore, the “emergency notification process” is started immediately and surely after the judgment of the “emergent time”. The step S3 and later indicate the “emergency notification process”.

In the step S3, the date and time data sent from the clock section 31 is received. When the emergency button 15 is pressed or the predetermined scream (or voice) is recognized by the sound processing section 40, in other words, at the “emergent time”, the date and time data indicating the date and time of the “emergent time” is sent from the clock section 31. Then, the date and time data is received and stored temporarily.

In the step S4, the current position of the portable radio device 10 at the “emergent time” is measured by the current position measuring section 34 and then, the position data thus obtained is stored in the position data storing section 35. Thereafter, the position data is read out from the section 35.

In the step S5, the image of an object at the “emergent time” is photographed by the digital camera section 32 and then, the image data thus obtained is stored in the image data storing section 37. Thereafter, the image data is read out from the section 37. If there is a time to spare for directing the lens 21 against the criminal at the “emergent time”, an image of the face or the like of the criminal will be obtained by photographing. However, according to the orientation of the lens 21 at the “emergent time”, there is a possibility that an image other than the person's image, such as a landscape of the scene, is obtained instead of the face of the criminal. In this case, because the orientation of the lens 21 was unable to be controlled at the “emergent time”, it is no use talking about it. However, even in that case, it seems to be often that the image of a landscape of the scene is useful for crime investigation. Thus, such the image is not always useless.

In the step S6, the sound at the “emergent time” is collected by the microphone 17 and then, the sound data obtained through the data processing is stored in the sound data storing section 42. Thereafter, the sound data is read out from the section 42. Since the sound data thus obtained might include the voice of the criminal, the sound of the car and/or tool (e.g., a gun) that was/were used by the criminal, or the sound that occurred in the scene, it seems to be often that the said sound data is helpful for the crime investigation.

In the step S7, the contact address data is read out from the contact address storing section 36. In addition, if it is set in such a way that the contact address data is not transmitted to the emergency notification apparatus 70 at the “emergent time”, the execution of the step S7 is omitted. In other words, the step S7 is skipped and the flow is jumped from the step S6 to the step S8.

In the step S8, the “ID number” of the owner (user) of the portable radio device 10 is combined with the date and time data, position data, image data, sound data and contact address data obtained in the steps S3 to S7, thereby generating the “emergency notification file” (see FIG. 4). At this time, the position data, image data, sound data and contact address data are linked with the date and time data, as explained previously.

In the step S9, the predetermined “emergency notification signal” is added to the “emergency notification file” generated in the step S8 and then, the “emergency notification file” is sent to the communication section 39. At this time, it is preferred that the “emergency notification file” is data-compressed to reduce the transmission volume.

In the step S10, the “emergency notification file” sent to the communication section 39 is transmitted to the outside along with the “ID number” and the “emergency notification signal”.

The “emergency notification file” and the “emergency notification signal” thus transmitted will arrive at the emergency notification apparatus 70 mounted in the private security company by way of the Internet 60. At the same time as this, they will arrive at the apparatus 70 by way of the portable telephone network. If both of the “emergency notification file” and the “emergency notification signal” have not been broken and can be used as they are, the “emergency notification file” and the “emergency notification signal” transmitted through the Internet 60 or those transmitted through the portable telephone network are utilized.

The emergency notification apparatus 70 extracts the date and time data, position data, image data, sound data, and contact address data from the “emergency notification file” thus arrived, link these data with the ID number of the user of the portable radio device 100, and stores the data thus linked in the notification data storing database 107. This point will be explained in detail later.

### Emergency Notification Apparatus Used in Emergency Notification System According to First Embodiment

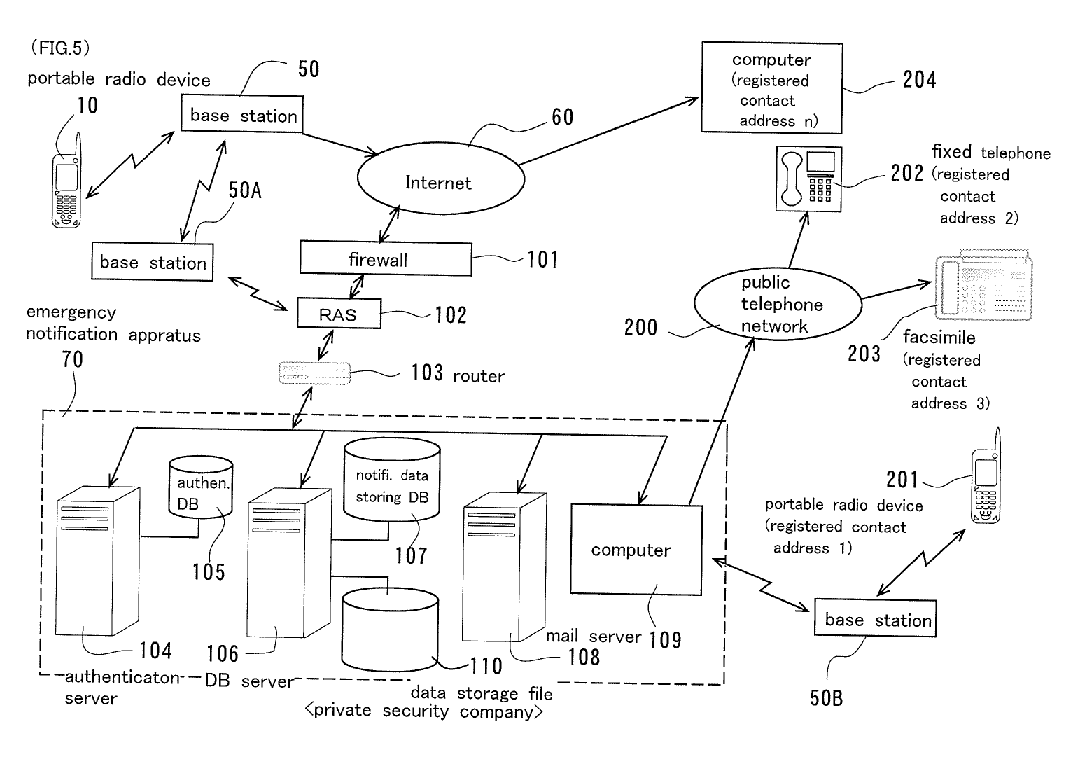

FIG. 5 is a functional block diagram showing the internal configuration of the emergency notification apparatus 70 placed in the private security company and the configuration of the related equipment thereto.

The emergency notification apparatus 70 is installed in the local area network (LAN) (not shown) formed in the private security company, as shown in FIG. 5. The LAN (and therefore, the apparatus 70) in the company is constantly connected to the Internet 60 by way of a firewall 101, a remote access server (RAS) 102, and a router 103. The apparatus 70 comprises an authentication database 105, an authentication server 104 for performing the authentication operation using the server 104, a notification data storing database 107, a database server 106 for managing the database 107, a mail server 108 for controlling the transmission and reception of electronic mail, and a computer 109 for controlling the servers 104, 106, and 108 and for making a call (calling out) to the external telephones, facsimiles or computers as the registered contact addresses.

The firewall 101 has a function of preventing someone from trespassing on the LAN (i.e., ensuring the security of the LAN) in the security company from the Internet 60. Only authorized persons by the said security company can get access to the LAN. The access to the Internet 60 from the inside of the LAN is possible optionally.

The RAS 102 achieves the access to the LAN in the security company from the Internet 60 using the wired or wireless telephone lines. In FIG. 5, the portable radio device 10 and the said LAN (i.e., the respective servers 104, 106 and 108 and the computer 109 in the LAN) can be accessed to each other by way of the base stations 50 and 50A and the RAS 102. Only the authorized persons by the security company (i.e., the persons who were allowed to use the emergency notification apparatus 70) can access the LAN through the RAS 102. In addition, the RAS 102 has a function of automatically calling back the device 10 that has called the RAS 102, i.e., the callback function.

The router 103 connects the Internet 60 and the LAN (and therefore, the emergency notification apparatus 70) in the security company to each other. Electronic mail and data can be transmitted and received between the Internet 60, and the respective servers 104, 106, and 108 and the computer 109 in the LAN by way of the router 103.

Next, the functions of the respective servers 104, 106, and 108 and the computer 109 provided in the emergency notification apparatus 70 will be explained below.

The emergency notification service rendered by the private security company using the emergency notification apparatus 70 can be utilized by making a contract between the owner (user) of the portable radio device 10 and the said company. Therefore, a person who wants to receive the said service needs to make a contract to receive it with the said company in advance. After making the contract, a unique ID (identification) number is given to the person who has concluded the contract. At this time, the personal data of the said person, such as the ID number, the name, the (contact address) telephone number, the picture of the face, the voice, the fingerprint and so on, are registered in the authentication database 105 in advance. Here, it is supposed that the owner (user) of the above-described device 10 has already made such the contract as above.

The authentication server 104 judges whether the access to the LAN (and therefore, the emergency notification apparatus 70) in the security company, i.e., the “emergency notification file” and the “emergency notification signal” sent through the Internet 60, is transmitted by the authorized person (i.e., the contracted user) or not. This means that if the access is made by the contracted person to receive the emergency notification service (i.e., the contracted user), the said access is permitted; on the other hand, if the access is not made by such the person, the said access is rejected. This judgment can be easily performed by extracting the “ID number” from the “emergency notification file” and retrieving the said “ID number” in the authentication database 105. In other words, if an ID number that meets the said “ID number” is found in the database 105, it is immediately found that the person is the contracted user. If not, it is found that the person is not the contracted user.

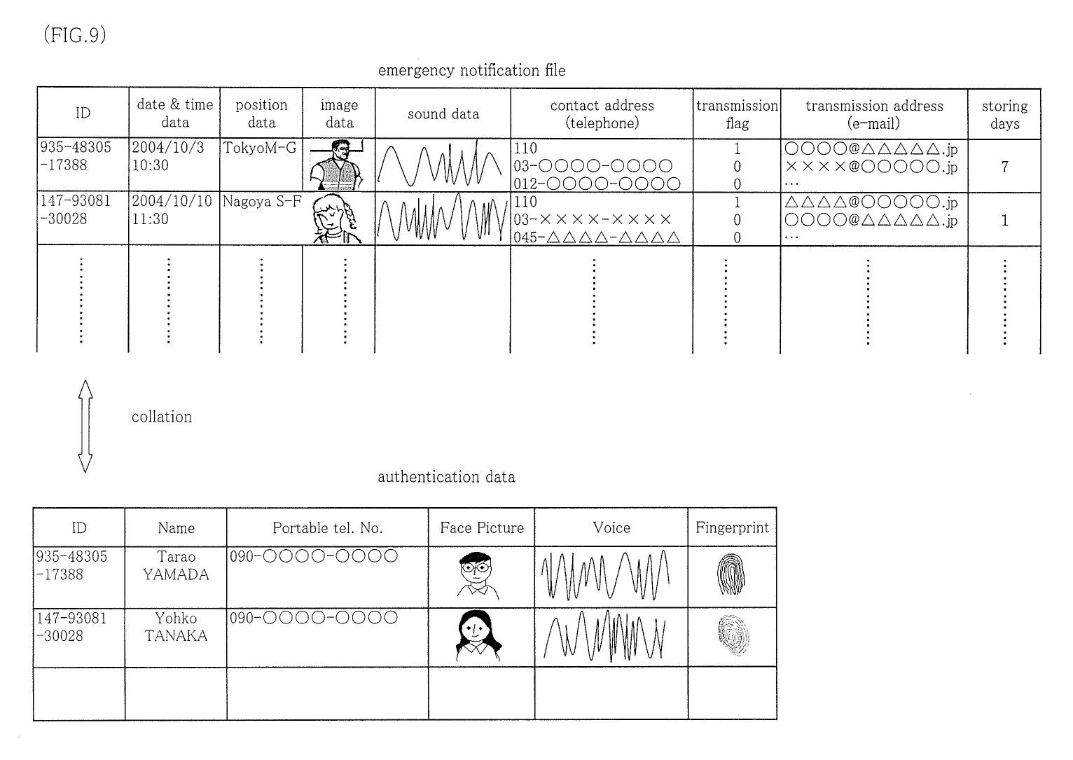

A concrete example of the content of the “emergency notification file” is shown in the upper table in FIG. 9. The authentication server 104 collates the “emergency notification file” of FIG. 9 with the authentication data stored in the authentication database 105 (see the lower table in FIG. 9) and judges whether the person is the registered user or not by examining the accordance or discordance of the ID number.

The database server 106 is provided to store the data available for the investigation of the crime, accident, or disaster in the database 107 after the classification by data type is completed. Specifically, if the access to the emergency notification apparatus 70 is permitted by the authentication server 104, the date and time data, position data, image data, sound data, and contact address data are extracted by the database server 106 from the transmitted “emergency notification file”. Then, the extracted data are linked with the ID number extracted previously and stored in the notification data storing database 107 of the database server 106. As a result, the date and time indicated by the date and time data (i.e., the date and time at which the state of emergency occurred), the position of the portable radio device 10 at that time, the image photographed at that time, and the sound collected at that time are linked with the ID number and thereafter, stored in the database 107. For this reason, the data available for the investigation of the crime, accident or disaster are automatically classified and stored.

In response to the “emergency notification signal”, the mail server 108 serves to automatically transmit electronic mail including the predetermined “danger message” to the contact addresses to which electronic mail is to be sent (i.e., the contact addresses where electronic mail addresses were registered) out of the registered contact addresses 1 to n. The content of the “danger message” may be simply set as “Mr./Ms. AA (the owner of the portable radio device 10) is in a dangerous state”. The time and position data at which the owner fell into the dangerous state may be or may not be included in the “danger message”. In the example of FIG. 5, an electronic mail is transmitted to the external computer 204 (i.e., the registered contact address n) through the Internet 60.

In response to the “emergency notification signal”, the computer 109 is installed to deliver a message including the “danger message” by voice to the contact addresses to which telephoning (call up) is to be made (i.e., the contact addresses where telephone numbers for portable or fixed telephones were registered) out of the registered contact addresses 1 to n. Moreover, the computer 109 serves to deliver a message including the “danger message” in writing to the contact addresses to which transmission is to be made by facsimile (i.e., the contact addresses where facsimile numbers were registered) out of the registered contact addresses 1 to n. In the example of FIG. 5, the computer 109 gives a call to the portable radio device 201 (registered contact address 1) by radio by way of the base station 50B and then, communicates orally the “danger message” to the user of the device 201 or communicates it to the said user by reproducing the previously recorded voice. Alternately, the computer 109 gives a call to the fixed telephone 202 (registered contact address 2) by way of the public telephone network 200 and then, communicates orally the “danger message” to the user of the telephone 202 or communicates it to the said user by reproducing the previously recorded voice. Alternately, the computer 109 gives a call to the facsimile 232 (registered contact address 3) by way of the public telephone network 200 and then, transmits a document on which the “danger message” was written to the facsimile 232.

Needless to say, the operation of transmitting electronic mail to the contact addresses to which electronic mail is to be sent out of the registered contact addresses 1 to n may be performed by the computer 109, instead of the mail server 108.

The “danger message” communicated by voice at the telephone may be the same as that transmitted by electronic mail. However, it may be different while taking the fact that it is communicated by voice into consideration. In this case, it is preferred that when the registered contact address receives the telephone call, the “danger message” previously produced and recorded in a recording medium is reproduced by sound. However, a person may communicate it orally. The “danger message” communicated in writing by facsimile may be the same as that transmitted by electronic mail.

It is preferred that the time and position data and so on at which the person fell into the dangerous state are included in the “danger message”. This is because the person or organ that receives the “danger message” can find the outline of the state of emergency immediately. However, if some difficulty such as the complication of the processes occurs, they need not be included. In this case, the receiver makes an inquiry to the private security company by telephone, electronic mail or the like to know the time and position at which the person fell into the dangerous state.

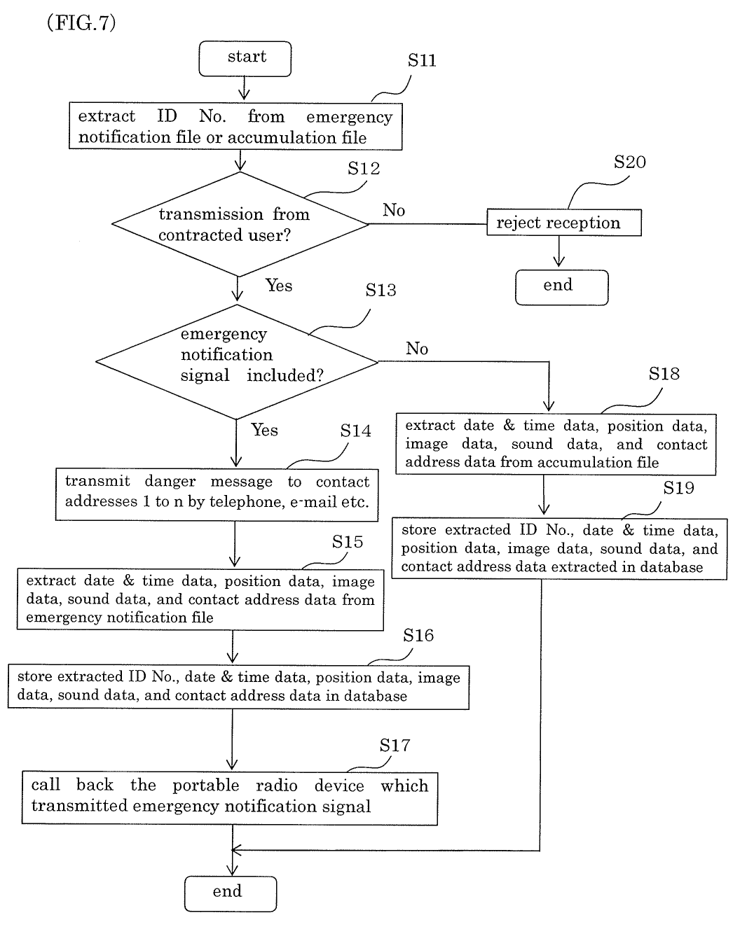

FIG. 7 is a flowchart showing the operation of the emergency notification apparatus 70.

In the step S11, the “emergency notification file” or an “accumulation file” transmitted from the portable radio device 10 is received and then, the ID number is extracted from it.

Here, the “accumulation file” is a file including the date and time data, position data, image data, sound data and registered contact address data similar to the “emergency notification file”. However, the “accumulation file”, which is transmitted at the time other than the emergent time, does not include the emergency notification signal. The “accumulation file” is prepared for enabling the owner of the portable radio device 10 to generate image data, position data, or sound data and to transmit these data thus generated to the emergency notification apparatus 70, thereby accumulating the said image, position, or sound data in the database 107 along with the date and time data, when the said owner of the device 10 senses an omen of stoking or other some danger excluding the emergent time. This is because these data accumulated (stored) in the database 107 can be used as the evidence when a crime occurs later.

In the step S12, it is judged whether the transmission is performed by the person who made the contract for providing the emergency notification service with the private security company (contracted user) or not. If the result is “No”, the flow is jumped to the step S20, where the reception is rejected and the said process is ended immediately. If the result is “Yes”, the flow advances to the step S13, where whether “emergency notification signal” is sent or not is judged. If the result is “Yes”, the flow advances to the step S14. If the result is “No”, the flow is jumped to the step S18.

In the step S14, the predetermined “danger message” is transmitted to the respective registered contact addresses 1 to n by telephone, facsimile, electronic mail or the like.

In the step S15, the date and time data, position data, image data, sound data, and registered contact address data are extracted from the “emergency notification file” thus transmitted.

In the step S16, the date and time data, position data, image data, sound data, and registered contact address data thus extracted are linked with the ID number extracted previously and then, they stored in the notification data storing database 107.

In the step S17, the portable radio device 10, which has transmitted the emergency notification signal to the apparatus 70, is called back with the RAS 102. Thus, if the owner of the said device 10 is in a state where he/she can respond to the said telephone call, the situation can be confirmed on the spot. If the owner of the said device 10 cannot respond to the said call, it can be presumed that he/she is in a situation where he/she cannot respond to the call. After the call back is completed, the operation is ended.

If the result in the step S13 is “No”, the flow advances to the step S17. In the step S17, similar to the step S15, the date and time data, position data, image data, sound data, and registered contact address data are extracted from the “accumulation file” thus transmitted. Then, in the next step S19, similar to the step S16, the date and time data, position data, image data, sound data, and registered contact address data thus extracted are linked with the ID number extracted previously and then, they are stored in the notification data storing database 107. Thereafter, the operation is ended.

When a predetermined period has passed after the storing of the date and time data, position data, image data, sound data, and registered contact address data in the database 107 along with the linkage with the ID number by the database server 106, these data are deleted from the database 107 and moved to the data storage file 110. In this case, there is an advantage that the total data quantity of the database 107 is decreased due to the deletion of the said data and the retrieving speed is improved. On the other hand, since the data thus deleted are stored in the data storage file 110, they can be utilized by retrieving the file 110 if they are required in the future. Thus, no problem occurs.

With the portable radio device 10, when the cancellation button 20 is pressed immediately after the emergency button 15 is pressed, a message such as “the emergency notification process is stopped because the cancellation button is pressed” is displayed on the screen 12 of the device 10. At approximately the same time as this, a “stop signal” indicating the stop of the immediately preceding emergency notification signal is transmitted to the emergency notification apparatus 70 through approximately the same path as the emergency notification signal. When the apparatus 70 receives the “stop signal”, it stops its operation immediately and displays a message such as “the emergency notification process was cancelled” on the display device (not shown) connected to the computer 109 for giving a notice to the administrator of the apparatus 70.

### State of Use of the Emergency Notification System According to First Embodiment

Next, the state of use of the emergency notification system having the above-described configuration and function according to the first embodiment will be explained below.

In the ordinary time, the owner (user) of the portable radio device 10 may utilize the device 10 as a portable telephone having the photographing function with the digital camera and the position measuring function using the GPS. Moreover, recording of sound or voice is possible. Since these states of use are the same as those of known portable telephone, PDA, or portable data terminal, the explanation is omitted here.

When the user of the device 10 judges that he/she is in a state of danger, it is sufficient that he/she merely presses the emergency button 15. Only by that operation, the fact that the said user is in a dangerous state can be quickly notified to the registered contact addresses, i.e., the concerned persons and the related organs of the said user, such as the police, the private security company, and his/her family and friends, with reliability. Here, explanation is made while taking the stoking crime as an example.

When the owner (user) of the portable radio device 10 is likely to be damaged or has been damaged actually by a stoker, the said user presses the emergency button 15 immediately. In response to this, in the device 10, the emergency notification processing section 43 is activated at once and the predetermined “emergency notification process” (the sub-processes (1) to (8) explained above) is executed immediately. Thereafter, the “emergency notification file” and the “emergency notification signal” are promptly transmitted to the emergency notification apparatus 70. As a result, the apparatus 70 transmits the danger message to the contact addresses 1 to n immediately, thereby notifying the occurrence of the state of emergency.

When the emergency button 15 is unable to be pressed for some reason, it is sufficient that the said user seeks someone's help by giving a scream “augh” or uttering some words such as “help me”. In response, the voice or sound is taken into the sound processing section 40 by way of the microphone 17 and voice recognition is performed therein. If it is judged that the voice is the registered one, the sound processing section 40 sends the activation signal to the emergency processing section 43 and as a result, the predetermined “emergency notification process” is executed at once. Therefore, even if the said user is in such the dangerous scene that he/she is unable to press the emergency button 15, the danger message is notified with reliability.

As explained above, in principle, the position data, image data, and sound data transmitted from the portable radio device 10 are those generated at the time the emergency button 15 was pressed, which are transmitted to the emergency notification apparatus 70. If these data were not generated at the time the button 15 was pressed due to some reason, the data stored immediately before that time are transmitted to the apparatus 70.

However, in the case that the user of the device 10 thinks that he/she had better store data such as the image data, sound data and so on about the criminal to consider the occurrence of a crime in the future although imminent danger does not exist, he/she can photograph the figure of the stoker or the scene where followed by the stoker by operating the digital camera section 32, and store the image data thus obtained in the device 10 along with the date and time data and the position data. Moreover, the said user can transmit these data to the emergency notification apparatus 70 as the “accumulation file”, and store the said data in the apparatus 70. Alternately, if telephone harassment is given to the portable radio device 10, the said user may record the voice of the person who speaks to the user of the said device 10, the time of such the call, or the telephone number of the sending telephone and then, store the data thus obtained in the device 10 or transmit the said data to the apparatus 70 as the “accumulation file” and store them in the apparatus 70.

If so, when a crime occurs later, the user himself/herself of the portable radio device 10 or the authorized person by the said user, or a policeman, fireman or an investigator can acquire the data stored in the device 10 or the emergency notification apparatus 70 to thereby obtain the information advantageous for arrest of the criminal or diagnosis of the cause. This is very beneficial. In principal, the access to the stored data in the apparatus 70 is prohibited. However, if there is a warrant for permitting the access to the said data in a case such as criminal investigation, the said access should be permitted. Therefore, it is preferred that the authentication means for controlling the said access is designed to be releasable intentionally in such the case.

In addition, with the above-described first embodiment, considering the fact that the security guard or officer on standby can take an action immediately upon reception of the emergency notification, the emergency notification apparatus 70 is located in the private security company. However, the present invention is not limited to this. The apparatus 70 may be placed in, for example, a police office, a building or site of a civil or public enterprise, or a building possessed by an Internet Service Provider (IPS). The apparatus 70 may be placed in someone's home.

Moreover, with the above-described first embodiment, the “emergency notification signal” to be transmitted from the portable radio device 10 in a state of emergency may be omitted. In this case, whether the arrived file is the predetermined “emergency notification file” or not is judged and then, if the arrived file is judged the “emergency notification file”, the emergency notification process is executed at once.

### Second Embodiment

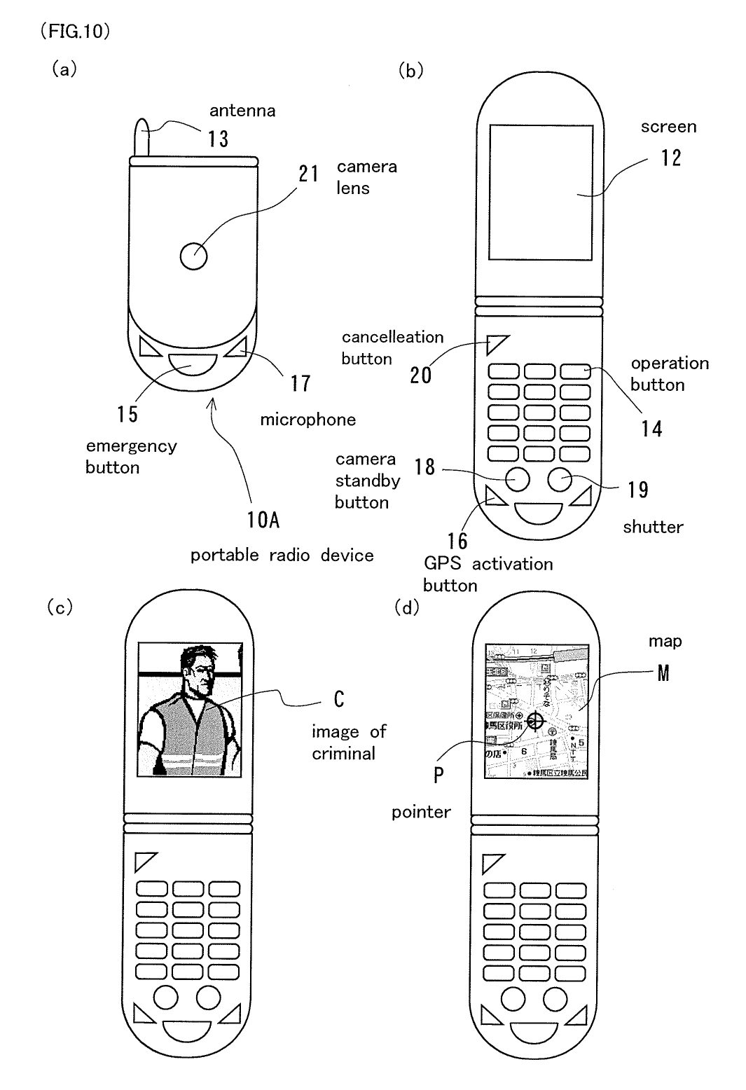

FIG. 10 is a drawing showing the appearance of a portable radio device 10A according to a second embodiment of the invention. This device 10A has the same configuration as that of the device 10 according to the above-described first embodiment except that the device 10A is foldable. Therefore, the detailed explanation about the device 10A is omitted here.

If the portable radio device 10A is used instead of the portable radio device 10 of the first embodiment and combined with the emergency notification apparatus 70, a system similar to the emergency notification system of the first embodiment can be configured. In this case, it is apparent that the same advantages as those in the first embodiment are obtainable.

### Third Embodiment

FIG. 3 is a drawing showing the appearance of a portable radio device 10B according to a third embodiment of the invention. This device 10B has the same configuration as that of the device 10 according to the above-described first embodiment except that the device 10B is configured in the form of watch. Therefore, the detailed explanation about the device 10B is omitted here.

If the portable radio device 10B is used instead of the portable radio device 10 of the first embodiment and combined with the emergency notification apparatus 70, a system similar to the emergency notification system of the first embodiment can be configured. In this case, it is apparent that the same advantages as those in the first embodiment are obtainable.

### VARIATIONS

The above-described first to third embodiments are concrete examples of the present invention. Therefore, needless to say, the present invention is not limited to these embodiments and any modification is applicable to them.

For example, in the above-described first embodiment, the emergency notification signal and the emergency notification file are transmitted to the emergency notification apparatus 70 placed in the private security company, and the apparatus 70 notifies it to the registered contact addresses 1 to n by making a call or sending electronic mail or the like. However, the invention is not limited to this. For example, the portable radio device 10 itself may transmit successively the emergency notification signal to the registered contact addresses 1 to n while transmitting the emergency notification signal and the emergency notification file to the apparatus 70.

Moreover, it is preferred that the contact address data indicating the registered contact addresses 1 to n are stored in the apparatus 70 in advance by, for example, transmitting the contact address data from the portable radio device 10. This is because the notification can be immediately performed to the registered contact addresses 1 to n by simply receiving the emergency notification signal. However, the invention is not limited to this. For example, it may examine whether the “contact address data” is included in the emergency notification file or not upon receipt of the emergency notification file transmitted from the device 10. If the “contact address data” is included, notification may be performed to the contact addresses corresponding to the contact address data; on the other hand, if the “contact address data” is not included, notification may be performed using the contact addresses data stored in the apparatus 70. In this case, such the examination function as above needs to be add to the authentication server 104; however, there is an advantage that if the contact address data are included in the emergency notification file, the storing operation of the contact address data in the database 107 is unnecessary, thereby raising the notification speed.

In the authentication operation to know whether the user of the device is the contracted user or not with the authentication server 104 in the apparatus 70, virus checking may be performed.

### INDUSTRIAL APPLICABILITY

The present invention is applicable to the uses necessitating the notification that a person is in a dangerous state (a state of emergency) quickly and surely to the concerned persons and the related organs of the said person, such as his/her family and/or acquaintances, the police, a private security company, and a firehouse by using a portable communication device having a GPS reception function, a photographing function with a digital camera and so on, when the said person encounters a crime, accident or disaster.

1. A portable radio device comprising:
emergency operation starting means provided to be operable by a user in an emergency;
date and time data generating means for generating date and time data;
position measuring means for measuring a position of the portable radio device to generate position data;
photographing means for photographing an object to generate image data;
emergency processing means for executing a predetermined emergency notification process when the emergency operation starting means is operated, thereby generating emergency notification data; and
communication means for transmitting by radio the emergency notification data toward an external emergency notification apparatus along with a predetermined emergency notification signal;
wherein the emergency notification process comprises a step of generating date and time data indicating a date and time when the emergency operation starting means is operated with the date and time data generating means, a step of generating position data by measuring a position of the device when the emergency operation starting means is operated with the position measuring means, a step of generating image data by photographing an object with the photographing means when the emergency operation starting means is operated, and a step of generating the emergency notification data by adding a predetermined identification data to the date and time data, the position data, and the image data;
and wherein the emergency notification signal is a signal that instructs the emergency notification apparatus to make a notification that the user of the device is in a state of emergency to predetermined contact addresses.

2. The device according to claim 1, further comprising a sound collecting microphone and a sound processing means for processing sound collected by the microphone to generate sound data;
wherein when the emergency operation starting means is operated, sound is collected by the microphone and sound data is generated, and the sound data is included in the emergency notification data.

3. The device according to claim 1, further comprising a sound collecting microphone, and a sound processing means for processing sound collected by the microphone to generate sound data;
wherein the sound processing means conducts voice or speech recognition using the sound data to judge whether the emergency notification process is necessary or not; and
if the sound processing means judges that the emergency notification process is necessary, the sound processing means causes the emergency processing means to execute the emergency notification process.

4. The device according to claim 1, further comprising contact address storing means for storing contact address data indicating the contact addresses;
wherein the contact address data stored in the contact address storing means is read out and then, included in the emergency notification data in the emergency notification process.

5. The device according to claim 1, wherein the contact address data indicating the contact addresses is not included in the emergency notification data.

6. The device according to claim 1, wherein the emergency processing section has a function of adding an identification code of the portable radio device to the date and time data generated by the date and time data generating means, the position data generated by the position measuring means, and the image data generated by the photographing means to generate an accumulation data, and of transmitting the accumulation data toward the emergency notification apparatus by the communication means.

7. The device according to claim 1, wherein the communication means transmits the emergency notification data and the emergency notification signal toward the emergency notification apparatus by way of a plurality of paths.

8. An emergency notification apparatus, which is designed to receive and store emergency notification data transmitted from outside and that receives an emergency notification signal transmitted with the emergency notification data to perform a predetermined emergency notification process;
the apparatus comprising:
authentication means for judging whether a transmitter of emergency notification data is an authorized person or not by extracting identification data from the emergency notification data and verifying the identification data;
signal detection means for judging whether the emergency notification signal is received or not along with the emergency notification data;
database management means for extracting date and time data, and position data and image data linked with the date and time data from the emergency notification data, and for storing the date and time data, the position data, and the image data thus extracted in a database in such a way as to have a relation with the identification data; and
notification means for performing a notification that the transmitter of the emergency notification data is in a state of emergency to predetermined contact addresses by performing the emergency notification process, when the signal detection means judges the emergency notification signal is received.

9. The apparatus according to claim 8, wherein the emergency notification data includes sound data.

10. The apparatus according to claim 8, wherein the emergency notification data includes contact address data indicating the contact addresses.

11. The apparatus according to claim 8, wherein the contact address data indicating the contact addresses is stored in the database in such a way as to have a relation with the identification data, and the notification is performed after reading out the contact address data from the database.

12. The apparatus according to claim 8, wherein when the signal detection means judges that the emergency notification signal is received, a callback to the transmitter of the emergency notification data is performed.

13. The apparatus according to claim 8, wherein when a predetermined period passes from at a time when the date and time data, the position data, and the image data extracted from the emergency notification data are stored in the database in such a way as to have the relation with the identification data, the database management means eliminates from the database the date and time data, the position data, and the image data thus extracted and moves them to a data storage file.

14. An emergency notification system comprising:
(a) a portable radio device comprising
i. emergency operation starting means provided to be operable by a user in an emergency:
ii. date and time data generating means for generating date and time data;
iii. position measuring means for measuring a position of the portable radio device to generate position data:
iv. photographing means for photographing an object to generate image data;
v. emergency processing means for executing a predetermined emergency notification process when the emergency operation starting means is operated, thereby generating emergency notification data; and
vi. communication means for transmitting by radio the emergency notification data toward an external emergency notification apparatus along with a predetermined emergency notification signal;
wherein the emergency notification process comprises a step of generating date and time data indicating a date and time when the emergency operation starting means is operated with the date and time data generating means, a step of generating position data by measuring a position of the device when the emergency operation starting means is operated with the position measuring means, a step of generating image data by photographing an object with the photographing means when the emergency operation starting means is operated, and a step of generating the emergency notification data by adding a predetermined identification data to the date and time data, the position data, and the image data;
and wherein the emergency notification signal is a signal that instructs the emergency notification apparatus to make (execute) a notification that the user of the device is in a state of emergency to predetermined contact addresses; and
(b) an emergency notification apparatus, which is designed to receive and store emergency notification data transmitted from outside and that receives an emergency notification signal transmitted with the emergency notification data to perform a predetermined emergency notification process,
the apparatus comprising
i. authentication means for judging whether a transmitter of emergency notification data is an authorized person or not by extracting identification data from the emergency notification data and verifying the identification data;
ii. signal detection means for judging whether the emergency notification signal is received or not along with the emergency notification data;
iii. database management means for extracting date and time data, and position data and image data linked with the date and time data from the emergency notification data, and for storing the date and time data, the position data, and the image data thus extracted in a database in such a way as to have a relation with the identification data; and
iv. notification means for performing a notification that the transmitter of the emergency notification data is in a state of emergency to predetermined contact addresses by performing the emergency notification process when the signal detection means judges the emergency notification signal is received.
